(19) United States
(12) Patent Application Publication
(10) Pub. No.: US 2011/0287131 A1
(43) Pub. Date: Nov. 24, 2011

(54) HEAT MOISTURE TREATED CARBOHYDRATES AND USES THEREOF

(76) Inventors: Shoba Murali, Westport, CT (US); Peter Kaufman, Woodbridge, CT (US); Jeff S. Volek, Manchester, CT (US)

(21) Appl. No.: 12/998,820

(22) PCT Filed: Dec. 8, 2009
(86) PCT No.: PCT/US09/67105

§ 371 Date: Aug. 12, 2011

Related U.S. Application Data
(60) Provisional application No. 61/201,332, filed on Dec. 9, 2008.

(51) Int. Cl. A23L 1/0522; A23L 1/29

(52) U.S. Cl. 426/2

(57) ABSTRACT

A method of controlling serum insulin levels in an individual is disclosed. The method comprises the step of administering to the individual a food composition comprising heat and moisture treated starch (HMT starch).

### BACKGROUND OF THE INVENTION

1. Field of the Invention

The invention relates to a method of controlling serum insulin levels in an individual, and more particularly to a method of controlling serum insulin levels by administering to an individual a food composition comprising heat and moisture treated starch (HMT starch).

2. Brief Description of the Related Art

Maintenance of normal blood glucose (blood sugar) levels is absolutely critical for optimal health and exercise performance. In health, blood glucose levels are normally held within a narrow range despite intermittent feeding and wide variations in intake. Acute regulation of blood glucose is achieved by a coordinated hormonal system in which insulin has a dominate role. Dietary carbohydrate is an important stimulator of insulin. Under normal conditions, the increase in blood glucose following ingestion of carbohydrate is reduced by the action of insulin which shuttles glucose into cells. The ingestion of carbohydrate and the subsequent increase in insulin has another consistent effect; it reduces adipose tissue lipolysis (fat breakdown) and fat oxidation. The insulin response to carbohydrate foods varies widely and cannot be predicted based simply on the chemical structure.

Importantly, obesity and related disorders are often associated with dysregulation of blood glucose. An estimated one-third of adults in the U.S. have elevated fasting glucose levels, dramatically increasing their likelihood of developing Type 2 diabetes. A large body of scientific work has connected meal-induced elevations in blood sugar with adverse consequences (e.g., insulin resistance, impaired antioxidant status, inflammation, oxidative damage, vascular dysfunction) ultimately increasing risk of many diseases including diabetes, cardiovascular disease, and cancer.

Exercise and prolonged periods without food also pose a unique challenge on the body to prevent low blood sugar and fatigue. Existing carbohydrate-based products for athletes rapidly elevate blood glucose, which is often followed by a precipitous decline below normal if not consumed repeatedly. Ingestion of these products also elevates blood insulin levels and potently inhibits mobilization and utilization of fat as a fuel. These metabolic perturbations can have adverse consequences on exercise performance and energy balance for those attempting to lose body weight and body fat. Currently, there are no effective products that have a sustained release profile to maintain glycemia and insulin levels before, during, and after exercise.

These few examples point to the need for a fully absorbed carbohydrate that provides an uninterrupted flow of energy characterized by lower glucose and insulin excursions, and increased fat breakdown and oxidation.

In addition, maintenance of body weight, or more specifically fat mass, over time requires a delicate balance between factors that promote storage and oxidation of body fat. If dietary fat intake is matched by an equal rate of fat oxidation, then adipose tissue mass will be maintained. However, this ignores the importance of endogenous synthesis of fat from carbohydrate which can be significant especially in obese insulin resistance individuals. Certain forms of carbohydrate have a higher propensity to be converted to fat, such as simple sugars like fructose. Therefore a form of carbohydrate that does not increase insulin or preferentially convert to fat is preferred for better maintenance of fat balance in the body.

### SUMMARY OF THE INVENTION

In one aspect, the present invention is directed to a method of controlling serum insulin levels in an individual, the method comprising the step of administering to the individual a food composition comprising heat and moisture treated starch (HMT starch), the food composition containing from 0.5 to 800 grams of HMT starch.

This and other aspects will become apparent from reading the following detailed description of the invention.

### BRIEF DESCRIPTION OF THE FIGURES

The invention will be better understood by way of the following description and the accompanying Figures in which:

FIG. 1 is graph depicting an assay measuring serum glucose concentration over time in the presence of maltodextrin and HMT starch;

FIG. 2 is a graph depicting an assay measuring serum insulin concentration over time in the presence of maltodextrin and HMT starch;

FIG. 3 is a graph depicting an assay measuring serum glycerol concentration over time in the presence of maltodextrin and HMT starch;

FIG. 4 is a graph depicting an assay measuring serum free non-esterified fatty acids (NEFA) concentration over time in the presence of maltodextrin and HMT starch; and

FIG. 5 is a graph depicting fat oxidation over time in the presence of maltodextrin and HMT starch.

### DESCRIPTION OF THE INVENTION

The present invention relates to methods of controlling serum insulin levels, markers of fat breakdown, and fat oxidation rates in mammals. The present inventors have unexpectedly discovered that ingestion of certain starches modified by a heat moisture treatment induce a lower rise in blood insulin concentrations while causing a substantially simultaneous increase in blood fatty acids and glycerol levels and rate of fat oxidation. These effects are evident at rest, during exercise and during recovery from exercise. These findings suggest that supplying a heat-moisture treated starch alters the endocrine response and encourages the body to rely more on endogenous fat for energy compared to unmodified starches such as maltodextrin.

Accordingly, in one aspect, the invention is directed to a method of controlling serum insulin levels, the method comprising the step of administering to the individual a food composition comprising heat and moisture treated starch (HMT starch). The method of the invention also results in a lower rise in blood insulin concentrations compared to an equivalent amount of maltodextrin, as well as a simultaneous increase in blood fatty acid levels, and a simultaneous increase in fat oxidation. The method of the invention may also further sustain normal glucose levels for an extended period of time.

The starches used in the method of the present invention are preferably waxy starches having an amylopectin content of at least 70%, preferably at least 80%, more preferably at least 85%, even more preferably at least 90%, yet more preferably at least 95%, most preferably at least 98% amylopectin. Such waxy starches may be cereal or non-cereal waxy starches. Preferably, the waxy starch is a waxy cereal starch, for example waxy maize starch.

Heat-moisture treated starches are disclosed in International Patent Application Publication WO 2005/044284, herein incorporated by reference in its entirety. Briefly, the inventors have found that good results according to the method of the invention are obtained when using heat-moisture treatment (e.g., a process utilizing high temperature and low moisture). Heat and moisture treated starch (HMT starch) is typically produced by exposing moist starch (e.g. 15-30% moisture) to temperatures of e.g. 95° C. to 130° C. for periods up to 30 hours (typically 16-24). These ranges do not exclude other heat-moisture profiles. For example, HMT starch for use in the invention may be produced by thermally treating starch in a sealed container under the following conditions: 20% moisture and 105° C. for 16 hours. The treated starch may then be cooled to room temperature, air-dried and then passed through 300 um sieve. Such heat moisture treatment results in a number of significant property changes to starches. The extent of the effect varies with the type of starch but in general the effects are: increased gelatinization temperature; reduced water absorption and swelling power; changed X-ray diffraction pattern; and increased enzyme susceptibility Although heat moisture treatment results in starches having increased susceptibility to enzymatic degradation, the inventors have surprisingly shown that when used in methods of the invention, heat moisture treated starches provide significantly greater prolongation of the time period over which insulin levels and serum glucose levels are maintained compared to the corresponding non heat moisture treated starches.

It should be noted that there are in the literature descriptions of carbohydrates, particularly resistant starches, that have less insulin response and higher levels of fat oxidation than other carbohydrates, particularly sugars. However, these starches are modified with chemical processes or alcohol modification, and these resistant starches do not fully digest, so they do not provide much glucose to be used as fuel, particularly by athletes, but rather remain less than fully digested as fiber in the colon. See, for example, U.S. Pat. No. 5,695,803 and U.S. Patent Application Ser. No. 2004/0096560 to Sharp et al. See also Johannsen and Sharp, Intl. J. Sport Nut. and Ex. Met. 17: 232-243 (2007), where alcohol modified starch is disclosed. By contrast, the heat-moisture treated starches and associated methods disclosed herein are distinguishable because they are completely digested and absorbed in the intestines providing a steady source of glucose into the bloodstream, while causing little insulin response and higher levels of fat oxidation.

In use, the HMT starch and method of the present invention induces a lower rise in blood insulin concentrations while causing a substantially simultaneous increase in blood fatty acids and fat oxidation compared to an equivalent amount of other carbohydrates used in sports nutrition products, in weight management products, and in many food products. Accordingly, the starch and method of the invention are particularly useful as food products or supplements for these applications. It has been observed that the starches and methods of the present invention, when consumed with other proteins, fats, or nutrients, also provide much glucose and prevent the spike and crash associated with other carbohydrates, and sustains normal glucose levels for an extended period of time. A preferably dosage of HMT starch ranges from about 0.005 to about 10 grams HMT starch per kilogram of body weight. A more preferable dosage of HMT starch ranges from about 0.05 to about 2 grams HMT starch per kilogram of body weight. Most preferably, a range of dosages of HMT starch is from about 0.1 to about 1 gram HMT starch per kilogram of body weight. In a preferred embodiment, the food composition of the invention contains from about 0.5 to about 800 grams of HMT starch, more preferably from about 4 to about 160 grams of HMT starch, and most preferably, from about 8 to about 80 grams of HMT starch.

Research supports that biasing metabolism to emphasize fat breakdown and oxidation is an effective and intuitive approach to avoid weight and fat gain. The relative amount of carbohydrate and fat used for fuel can measured using indirect calorimentry and is expressed as the respiratory quotient or RQ. A lower RQ is indicative of a greater reliance on fat versus carbohydrate. Two studies provide convincing evidence that an ability to maintain a lower RQ in response to a standardized diet results in a more favorable fat balance and less long-term weight gain. In one study (1) 24 hour RQ was measured in a metabolic chamber while individuals were fed a standard diet. A low RQ was associated with increased fat mass and subsequent weight gain independent of energy intake and expenditure. Subjects with higher 24-h RQ independent of 24-h energy expenditure were at 2.5 times higher risk of gaining more than 5 kg body weight than those with lower 24-h RQ. In another study (2), it was discovered that obese individuals with a high RQ were more likely to regain weight at two-year follow-up, whereas obese patients who succeeded in maintaining weight loss were characterized by a significantly lower RQ. These studies point to a high RQ being indicative of lower fat oxidation as being predictive of long-term body weight gain. See, Zurlo F, et al., Am J Physiol. (1990) 259:E650-7; Hainer V, et al., Sb Lek (2000) 101:99-104.

HMT starch has been shown to produce less of an insulin response and a lower RQ indicating increased fat oxidation, and therefore has application in weight management programs when used as a replacement for other carbohydrate sources.

Thus, the methods and HMT starches disclosed herein have the following advantages.
1) They extend maintenance of blood glucose levels—for athletes as well as for normal humans, while exercising and at rest.
2) They do not produce a spike and crash common to other carbohydrates.
3) When implemented in the method of the invention, the HMT starches induce a lower rise in blood insulin concentrations while causing a substantially simultaneous increase in blood fatty acids and fat oxidation compared to an equivalent amount of other carbohydrates used in sports nutrition products, in weight management products, and in many food products.
4) The HMT starches are created completely naturally, with no chemical additives, chemical processes, or alcohol modification.
5) The HMT starches completely digest, unlike resistant starches that do not completely digest, do not throw off much glucose for use by the body, and end up as fiber in the colon.
6) The HMT starches do not have a high propensity to be converted to fat, which is the case for fructose.

### EXAMPLE

### Example 1

This study examined the metabolic response of ingesting a heat-moisture treated (HMT) starch compared to maltodextrin. The source of HMT starch for this study was purchased from Glycologic Ltd (Scotland, UK) as described in WO 2005/044284.

Ten male cyclists (age: 30±2 y, weight: 79.2±2.1 kg, VO2peak: 4.7±0.1 L/min, training: 7.5±1.3 y) fasted for 12-h before completing 150 min of cycling at 70% VO_{2 peak}. Before and after exercise, participants ingested 1 g/kg of either heat-moisture treated starch or maltodextrin while providing blood and expired gas samples every 15 and 30 min before exercise, during exercise and during passive recovery.

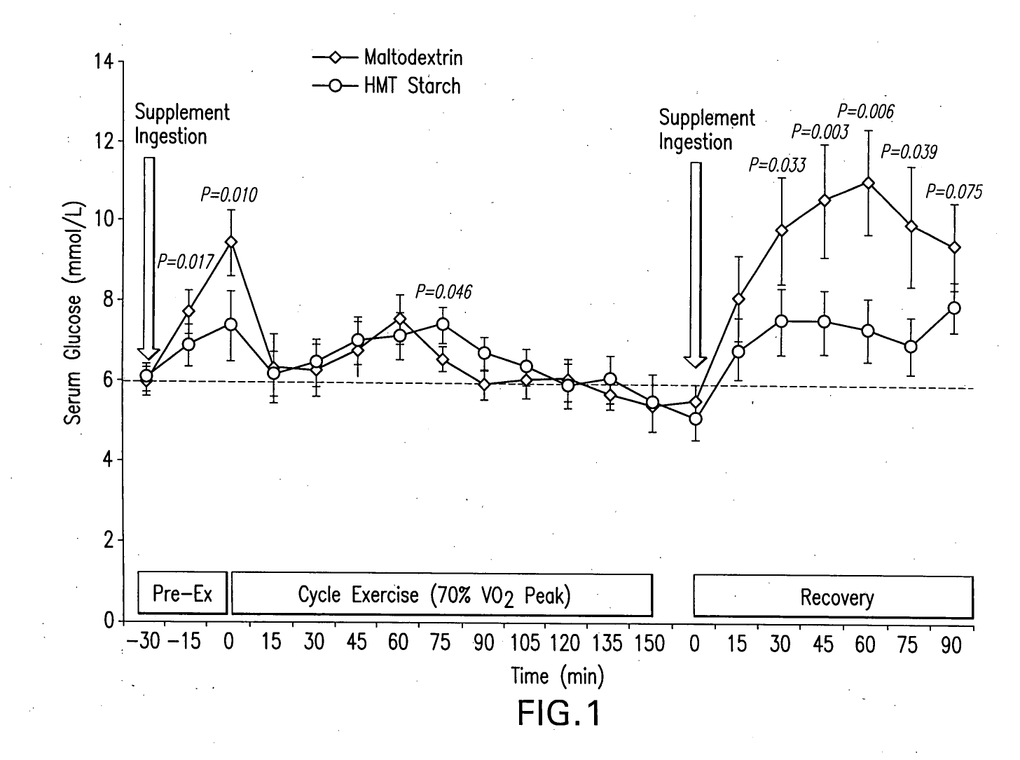

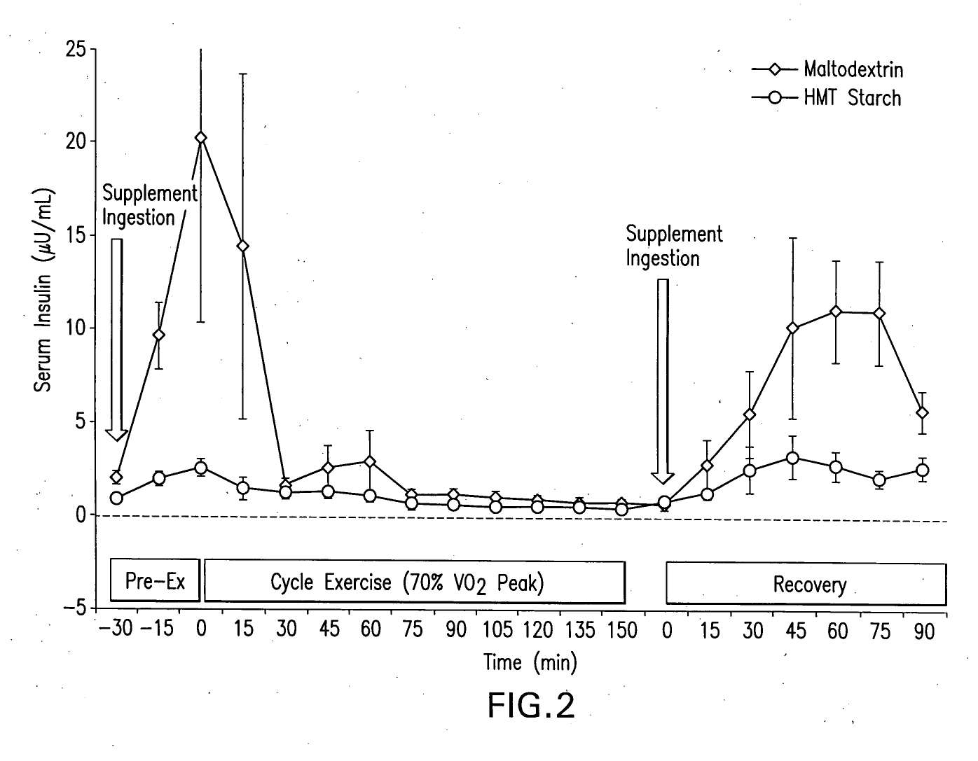

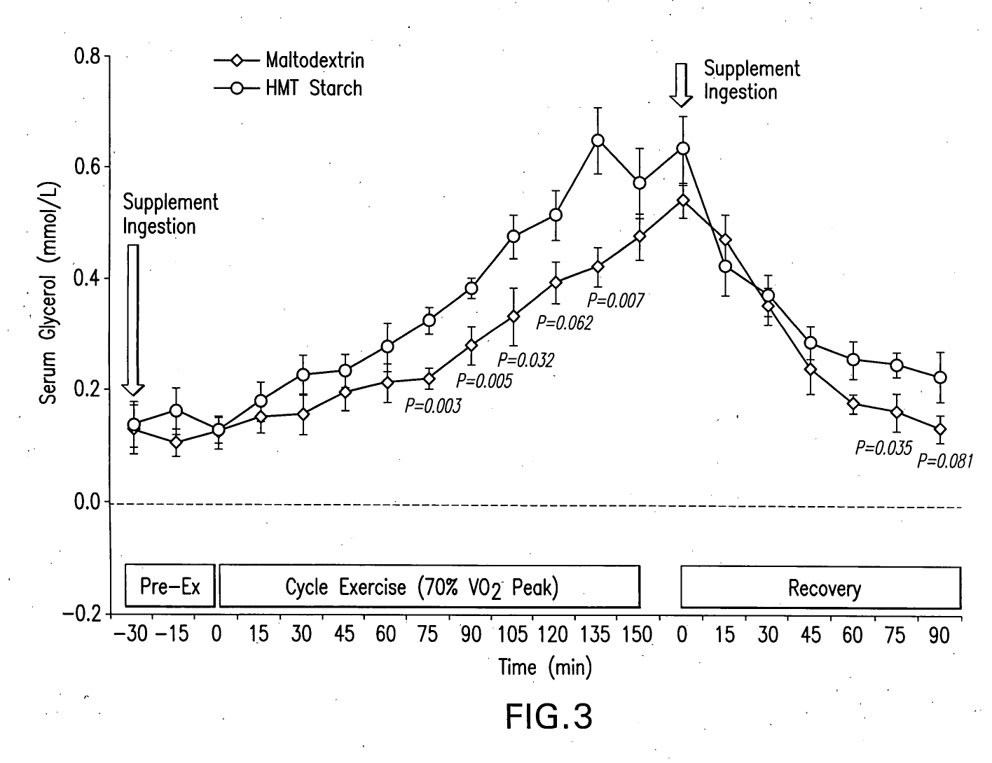

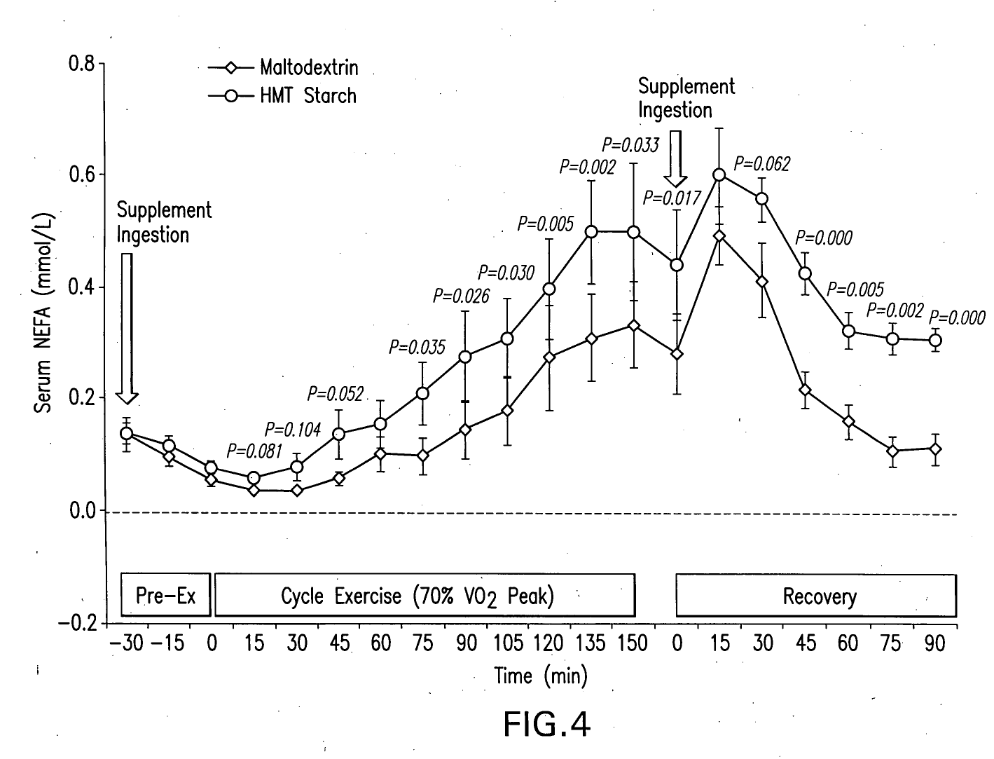

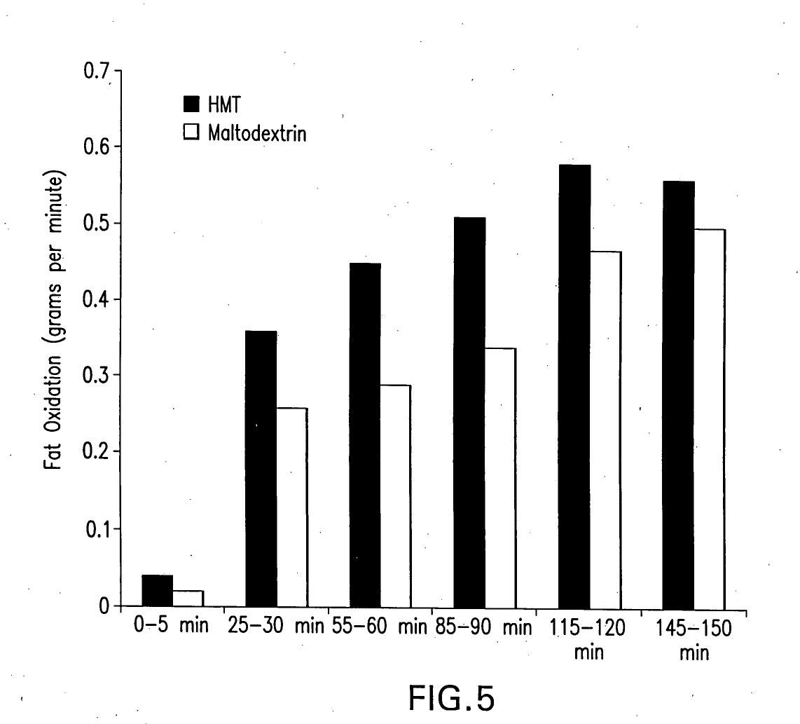

In a crossover fashion, identical testing was completed one week later. Blood was assayed using known protocols for serum glucose (FIG. 1), insulin (FIG. 2), glycerol (FIG. 3), and free non-esterified fatty acids (NEFA, FIG. 4). Expired gases were analyzed for carbohydrate and fatty acid oxidation rates. Fat oxidation over time was also analyzed (FIG. 5). Compared to maltodextrin, heat-moisture-treated starch ingestion resulted in lower insulin and higher fatty acid and glycerol levels, as well as higher rates of fat oxidation.

What is claimed is:

1. A method of controlling serum insulin levels in an individual, said method comprising the step of administering to said individual a food composition comprising heat and moisture treated starch (HMT starch), said food composition containing from 0.5 to 800 grams of HMT starch.

2. The method of claim 1, wherein said method results in a lower rise in blood insulin concentrations compared to an equivalent amount of maltodextrin.

3. The method of claim 1, wherein said method further causes a simultaneous increase in blood fatty acid levels.

4. The method of claim 1, wherein said method further causes a simultaneous increase in fat oxidation.

5. The method of claim 1, wherein said method further sustains normal glucose levels for an extended period of time.

6. The method of claim 1, wherein said HMT starch is produced by exposing moist starch to temperatures ranging from about 95° C. to 130° C. for a time periods of up to 30 hours.

7. The method of claim 6, wherein said moist starch contains about 15-30% moisture.

8. The method of claim 6, wherein said time period ranges from 16-24 hours.

9. The method of claim 6, wherein said moist starch is a waxy starch having an amylopectin content of at least 70%.

10. The method of claim 6, wherein said waxy starch is waxy maize starch.

11. The method of claim 1, wherein said HMT starch is produced by exposing waxy maize starch having an amylopectin content of at least 70% and a moisture content of about 20% to a temperature of about 105° C. for about 16 hours.

12. The method of claim 1, wherein said method is used for weight loss or weight management.

13. The method of claim 1, wherein said food composition contains from 4 to 160 grams of HMT starch.

14. The method of claim 1, wherein said food composition contains from 8 to 80 grams of HMT starch.

15. The method of claim 1, wherein said HMT starch in said food composition ranges from 0.005 to 10 grams per kilogram of body weight of said individual.

16. The method of claim 1, wherein said HMT starch in said food composition ranges from 0.05 to 2 grams per kilogram of body weight of said individual.

17. The method of claim 1, wherein said HMT starch in said food composition ranges from 0.1 to 1 gram per kilogram of body weight of said individual.
